(19) United States
(12) Patent Application Publication
(10) Pub. No.: US 2020/0231836 A1
(43) Pub. Date: Jul. 23, 2020

(54) AQUEOUS COATING MATERIAL, COATING FILM AND METHOD FOR PRODUCING SUBSTRATE WITH COATING FILM

(71) Applicant: AGC Inc., Chiyoda-ku (JP)

(72) Inventors: Shun SAITO, Chiyoda-ku (JP); Shuhei OCHI, Chiyoda-ku (JP); Shiori YOSHIGAMI, Chiyoda-ku (JP)

(73) Assignee: AGC Inc., Chiyoda-ku (JP)

(21) Appl. No.: 16/836,994

(22) Filed: Apr. 1, 2020

Related U.S. Application Data
(63) Continuation of application No. PCT/JP2018/036378, filed on Sep. 28, 2018.

(30) Foreign Application Priority Data
Oct. 2, 2017 (JP) 2017-192896

(51) Int. Cl. C09D 127/12; C09D 7/63; C09D 7/65

(52) U.S. Cl. CPC C09D 127/12; C09D 7/65; C09D 7/63

(57) ABSTRACT

To provide an aqueous coating material which is capable of forming a coating film excellent in stain resistance; a coating film; and a method for producing a substrate with a coating film. An aqueous coating material of the present invention comprises a fluorinated non-block copolymer which comprises units based on a fluoroolefin and units having a hydrophilic group, a fluorinated block copolymer which has a fluorinated segment comprising units based on a monomer having a perfluoroalkyl group and a non-fluorinated segment containing no fluorine atom, an anionic surfactant, of which the HLB value is at least 17.5, and water.

This application is a continuation of PCT Application No. PCT/JP2018/036378, filed on Sep. 28, 2018, which is based upon and claims the benefit of priority from Japanese Patent Application No. 2017-192896 filed on Oct. 2, 2017. The contents of those applications are incorporated herein by reference in their entireties.

### TECHNICAL FIELD

The present invention relates to an aqueous coating material, a coating film and a method for producing a substrate with a coating film.

### BACKGROUND ART

From the viewpoint of environmental protection, in the field of coating materials, attention has been drawn to an aqueous coating material using water as a solvent for the coating material. Further, from the viewpoint of coating film properties such as weather resistance, chemical resistance, solvent resistance, etc., an aqueous coating material comprising a fluorinated polymer is expected.

Patent Document 1 discloses an aqueous coating material which comprises an aqueous dispersion containing water, an anionic surfactant and a nonionic surfactant and having dispersed in water a fluorinated polymer comprising units based on a fluoroolefin and units based on a monomer having a hydrophilic group.

### PRIOR ART DOCUMENT

### Patent Document

Patent Document 1: Japanese Patent No. 3414465

### DISCLOSURE OF INVENTION

### Technical Problem

In recent years, the performance required for a coating film formed from an aqueous coating material has become high, and a coating film excellent in stain resistance has been demanded. Here, a coating film excellent in stain resistance means a coating film on which dirt is less likely to be deposited, or a coating film from which dirt, if deposited, can easily be removed.

The present inventors have found that the coating film formed from the aqueous coating material comprising the aqueous dispersion as disclosed in Patent Document 1, still has a room for improvement in stain resistance.

In view of the above problem, the present invention has an object to provide an aqueous coating material capable of forming a coating film excellent in stain resistance as well as in hydrophilicity and oil repellency of the coating film; a coating film; and a method for producing a substrate with a coating film.

### Solution to Problem

The present inventors have intensively studied the above problem, and as a result, they have found it possible to obtain a coating film excellent in stain resistance, by using an aqueous coating material comprising a specific fluorinated non-block copolymer, a specific fluorinated block copolymer, an anionic surfactant, of which the HLB value is at least a predetermined value, and water, and thus have arrived at the present invention.

The present invention has the following embodiments.

[1] An aqueous coating material characterized by comprising a fluorinated non-block copolymer which comprises units based on a fluoroolefin and units having a hydrophilic group, a fluorinated block copolymer which has a fluorinated segment comprising units based on a monomer having a perfluoroalkyl group, and a non-fluorinated segment containing no fluorine atom, an anionic surfactant, of which the HLB value is at least 17.5, and water.
[2] The aqueous coating material according to [1], wherein the hydrophilic group is a hydroxy group, a carboxy group, or a group having a hydrophilic polyoxyalkylene chain.
[3] The aqueous coating material according to [1] or [2], wherein the units having a hydrophilic group are units based on a monomer having a hydrophilic group.
[4] The aqueous coating material according to any one of [1] to [3], which further contains a nonionic surfactant, of which the HLB value is at most 15.0.
[5] The aqueous coating material according to [4], wherein the content of the nonionic surfactant is from 0.01 to 15 parts by mass, to 100 parts by mass of the fluorinated non-block copolymer.
[6] The aqueous coating material according to any one of [1] to [5], wherein content of the fluorinated block copolymer is from 0.1 to 20 parts by mass, to 100 parts by mass of the fluorinated non-block copolymer, and the content of the anionic surfactant is from 0.01 to 5 parts by mass, to 100 parts by mass of the fluorinated non-block copolymer.
[7] The aqueous coating material according to any one of [1] to [6], wherein the fluorinated block copolymer contains units having a hydrophilic group, and units based on an alkyl (meth)acrylate.
[8] The aqueous coating material according to [7], wherein in the fluorinated non-block copolymer, the content of the units having a hydrophilic group is from 0.1 to 20 mol % to all units which the fluorinated non-block copolymer comprises, and in the fluorinated block copolymer, the content of the units having a hydrophilic group is from 1 to 20 mol % to all units which the fluorinated block copolymer comprises.
[9] The aqueous coating material according to any one of [1] to [8], wherein the content of the water is from 10 to 90 mass %, to the total mass of the aqueous coating material.
[10] The aqueous coating material according to any one of [7] to [9], wherein in each of the fluorinated non-block copolymer and the fluorinated block copolymer, the hydrophilic group includes a hydroxy group,

the hydroxy value in the fluorinated non-block copolymer is from 1 to 80 mgKOH/g, and

the hydroxy value in the fluorinated block copolymer is from 10 to 100 mgKOH/g.

[11] The aqueous coating material according to any one of [1] to [10], wherein the content of the fluorinated non-block copolymer to the total mass of the solid content which the aqueous coating material comprises, is from 40 to 95 mass %.
[12] The aqueous coating material according to any one of [1] to [11], wherein the content of fluorine atoms to the total mass of the solid content which the aqueous coating material comprises, is from 10 to 40 mass %.
[13] A method for producing a substrate with a coating film, characterized by applying the aqueous coating material as defined in any one of [1] to [12] on the surface of a substrate, to form a coating layer, and drying the coating layer to form a coating film. [14] A coating film formed from the aqueous coating material as defined in any one of [1] to [12], characterized in that the water contact angle to the coating film is less than 50°, and the oil contact angle to the coating film is at least 40°.

### Advantageous Effects of Invention

According to the present invention, it is possible to provide an aqueous coating material capable of forming a coating film excellent in stain resistance as well as in hydrophilicity and oil repellency of the coating film; a coating film; and a method for producing a substrate with a coating film.

### DESCRIPTION OF EMBODIMENTS

Meanings of the terms in the present invention are as follows.

A numerical range expressed by using “to” means a range including numerical values described before and after “to” as the lower and upper limits.

A “(meth)acrylate” is a general term for an acrylate and a methacrylate, and “(meth)acryl” is a general term for acryl and methacryl.

A “unit” is a general term for an atomic group formed directly by polymerization of a monomer and based on one molecule of the monomer, and an atomic group obtained by chemically converting a portion of such an atomic group. Here, the contents (mol %) of the respective units to all units which the polymer comprises, may be obtained by analyzing the polymer by a nuclear magnetic resonance spectroscopy, and they may also be determined from charged amounts of the components used at the time of the production of the polymer.

The “acid value” and “hydroxy value” are, respectively, values measured in accordance with the methods of JIS K 0070-3 (1992).

The “number average molecular weight” and “weight average molecular weight” are values measured by a gel permeation chromatography using polystyrene as a standard substance. The number average molecular weight may be referred to also as Mn, and the weight average molecular weight may be referred to also as Mw.

When a coating material contains a solvent, the solid content mass of the coating material is the mass obtained by removing the solvent from the coating material. Here, components constituting the solid content of the coating material, other than the solvent, will be regarded as the solid content even if their nature is liquid. Here, the mass of the solid content of a coating material is obtainable as the mass remaining after heating the coating material at 130° C. for 20 minutes.

The “fluorinated block copolymer” means a polymer compound composed of plural types of segments which are different in the types of the contained units, or which are, in the case of the same types, different in the compositions of the units, and wherein at least one segment has fluorine atoms.

The “fluorinated non-block copolymer” is a polymer compound having fluorine atoms in the molecule, and means a copolymer other than the above “fluorinated block copolymer”, and as a specific example, a polymer in which the binding order of different units is a random type or an alternating type.

The “content of fluorine atoms” means the proportion (mass %) of fluorine atoms to all atoms constituting the total solid content which the coating material comprises. The content of fluorine atoms is obtainable by measuring the solid content, which a fluorinated coating material comprises, by an automatic sample combustion apparatus-ion chromatography method (AQF-IC method) under the following conditions.

### <Analysis Conditions>

Automatic Sample Combustion Apparatus

Apparatus: manufactured by Mitsubishi Chemical Analytech Co., Ltd., AQF-100

Combustion conditions: solid sample mode, sample amount: 2 to 20 mg

Ion Chromatograph

Apparatus: manufactured by Thermo Fisher SCIENTIFIC K.K.

Column: IonpacAG11HC+IonpacAS11HC

Elution liquid: KOH10 mN (0-9 min), 10-16 mN (9-11 min), 16 mN (11-15 min), 16-61 mN (15-20 min), 60 mN (20-25 min), flow rate: 1.0 mL/min, suppressor: ASRS, detector: conductivity detector, injection volume: 5 μL

The “HLB value” is a value calculated by the following formula from the ratio of inorganic value (I) to organic value (O) (hereinafter referred to also as I/O value) in the organic conceptual diagram. Inorganic value and organic value can be calculated by the following formula, on the basis of each document, such as “Systematic organic qualitative analysis mixture Guide” (Atsushi Fujita et al., Kazamashobo, 1974), “Staining Theoretical Chemistry” (Nobuhiko Kuroki et al., Maki Shoten, 1966), “Organic compound separation method” (Hiroo Inoue, Shokabo, 1990), etc.

HLB value=(inorganic value (I)/organic value (O))×10

The aqueous coating material of the present invention is an aqueous coating material comprising a fluorinated non-block copolymer (hereinafter referred to also as polymer A) which comprises units (hereinafter referred to also as units F) based on a fluoroolefin and units (hereinafter referred to also as units A1) having a hydrophilic group, a fluorinated block copolymer (hereinafter referred to also as polymer B) which has a fluorinated segment (hereinafter referred to also as segment 1) containing units (hereinafter referred to also as units B1) based on a monomer (hereinafter referred to also as monomer B1) having a perfluoroalkyl group, and a non-fluorinated segment (hereinafter referred to also as segment 2) containing no fluorine atom, an anionic surfactant, of which the HLB value is at least 17.5, and water.

In the following, an anionic surfactant, of which the HLB value is at least 17.5 may be referred to also as a specific anionic surfactant. Further, the aqueous coating material of the present invention may be referred to also as the present coating material.

The coating film (hereinafter referred to also as the present coating film) obtainable by using the present coating material is excellent in stain resistance. The reason for this is not necessarily clear, but it is considered to be as follows.

The present coating material comprises polymer A, polymer B, the specific anionic surfactant and water. Therefore, at the boundary between the surface of the present coating film suitably hydrophilized by the specific anionic surfactant, and the inside of the present coating film presenting partially hydrophilic and hydrophobic properties by units F and units A1, polymer B having locally hydrophilic and hydrophobic moieties is specifically oriented.

Polymer B will be in such a state that the state in which segment 2 faces the surface of the present coating film while segment 1 faces the inside of the present coating film, and the state in which segment 1 faces the surface of the present coating film while segment 2 faces the inside of the present coating film, are alternately arranged.

Therefore, the surface of the present coating film is in such a state that hydrophilic parts and hydrophobic parts are uniformly present, whereby the present coating film is excellent in hydrophilicity, while it is excellent also in oil repellency. Accordingly, on the present coating film, dirt will be less likely to deposit, and dirt, if once deposited thereon, will be easily removed, whereby the present coating film is excellent in stain resistance.

In the following, polymer A will be described in detail.

A fluoroolefin is an olefin, of which at least one of hydrogen atoms is substituted by a fluorine atom. In the fluoroolefin, at least one of hydrogen atoms not substituted by fluorine atoms may be substituted by a chlorine atom.

Specific examples of the fluoroolefin may be CF₂═CF₂, CF₂═CFCl, CF₂═CHF, CH₂═CF₂, CF₂═CFCF₃, CF₂═CHCF₃, CF₃CH═CHF and CF₃CF═CH₂. As the fluoroolefin, from the viewpoint of copolymerizability, CF₂═CFCl, CF₂═CF₂, CF₃CH═CHF or CF₃CF═CH₂ is preferred, and CF₂═CFCl or CF₂═CF₂ is particularly preferred. As the fluoroolefin, two or more types may be used in combination.

The content of units F is preferably from 20 to 70 mol %, particularly preferably from 40 to 60 mol %, to all units which polymer A comprises, from the viewpoint of the weather resistance of the present coating film.

Units A1 may be units based on a monomer (hereinafter referred to also as monomer A1) having a hydrophilic group, or may be units obtainable by converting hydrophilic groups in a fluorinated polymer containing units A1, to different hydrophilic groups. As such units, units obtainable by reacting e.g. a polycarboxylic acid or its acid anhydride to a fluorinated polymer comprising units having hydroxy groups, to convert some or all of the hydroxy groups to carboxy groups. Here, units A1 are preferably units having no fluorine atoms, from the viewpoint of polymerizability with units based on a fluoroolefin.

Specific examples of the hydrophilic group, which units A1 have, may be a hydroxy group, a carboxy group, a group having a hydrophilic polyoxyalkylene chain, an amino group, and an alkoxysilyl group. From such a viewpoint that the hydrophilicity of the present coating film can be suitably adjusted, a hydroxy group, a carboxy group, or a group having a hydrophilic polyoxyalkylene chain, is preferred. As monomer A1, two or more types may be used in combination. Further, monomer A1 may have two or more types of hydrophilic groups.

The monomer having a carboxy group may be an unsaturated carboxylic acid, (meth)acrylic acid, etc. As the monomer having a carboxy group, preferred is a monomer (hereinafter referred to as monomer A11) represented by the formula X¹¹—Y¹¹.

X¹¹ is CH₂═CH—, CH(CH₃)═CH— or CH₂═C(CH₃)—, and CH₂═CH— or CH(CH₃)═CH— is preferred.

Y¹¹ is a carboxy group, or a C₁₋₁₂ monovalent saturated hydrocarbon group having a carboxy group, and a carboxy group or a C₁₋₁₀ carboxyalkyl group is preferred.

Specific examples of monomer A11 may be CH₂═CHCOOH, CH(CH₃)═CHCOOH, CH₂═C(CH₃)COOH, and CH₂═CH(CH₂)ₙ₂COOH (where n2 represents an integer of from 1 to 10).

Examples of the monomer having a hydroxy group may be an allyl alcohol, and a vinyl ether, vinyl ester, allyl ether, allyl ester or (meth)acrylic acid ester having a hydroxy group. Among them, allyl alcohol, or a monomer represented by the formula X¹²—Y¹² (hereinafter referred to also as monomer A12) is preferred. Here, in a case where the monomer has a polyoxyalkylene chain, even if it has a hydroxy group, it shall be regarded as a monomer having a polyoxyalkylene chain.

X¹² is CH₂═CHO—, CH₂═CHCH₂O—, CH₂═CHOC(O)—, CH₂═CHCOO—, or CH₂═C(CH₃)COO—.

Y¹² is a C₂₋₁₂ monovalent saturated hydrocarbon group having a hydroxy group. The monovalent saturated hydrocarbon group may be linear or branched. Further, the monovalent saturated hydrocarbon group may be made of a ring structure, or it may contain a ring structure.

The monovalent saturated hydrocarbon group is preferably a C₂₋₆ alkyl group, or an alkyl group containing a C₆₋₈ cycloalkylene group.

Specific examples of monomer A12 may be CH₂═CHO—CH₂-cycloC₆H₁₀—CH₂OH, CH₂═CHCH₂O—CH₂-cycloC₆H₁₀—CH₂OH, CH₂═CHOCH₂CH₂OH, CH₂═CHCH₂OCH₂CH₂OH, CH₂═CHOCH₂CH₂CH₂CH₂OH, CH₂═CHCH₂OCH₂CH₂CH₂CH₂OH, CH₂═CHCOOCH₂CH₂OH, and CH₂═C(CH₃)COOCH₂CH₂OH. Here, “-cycloC₆H₁₀—” represents a cyclohexylene group, and the bonding sites of -cycloC₆H₁₀— are usually 1,4-.

An example of the monomer having a hydrophilic polyoxyalkylene chain, may be a vinyl ether, vinyl ester, allyl ether, allyl ester or (meth)acrylic acid ester having a hydrophilic polyoxyalkylene chain.

The hydrophilic polyoxyalkylene chain is preferably a polyoxyethylene chain, or a polyoxyalkylene chain composed mainly of oxyethylene groups and containing an oxyalkylene group with 3 or more carbon atoms to such an extent that the hydrophilicity is not inhibited. As the oxyalkylene group with 3 or more carbon atoms, a C_{3 or 4} oxyalkylene group may be mentioned, and an oxypropylene group is preferred. As the hydrophilic polyoxyalkylene chain, a polyoxyethylene chain is preferred. In a case where it contains an oxyalkylene group with 3 or more carbon atoms, the number of oxyethylene groups is preferably at least 60%, more preferably at least 80%, to the number of all oxyalkylene groups in the polyoxyalkylene chain.

In a case where the hydrophilic polyoxyalkylene chain is a copolymer chain of oxyalkylene groups having 3 or more carbon atoms and oxyethylene groups, their binding sequence may be a random type or a block type.

The terminal of the hydrophilic oxyalkylene chain may be a hydrophilic group such as the above hydroxy group, or may be a group which is not the above hydrophilic group, such as an alkoxy group. As the group which is not the above hydrophilic group, an alkoxy group having 4 or less carbon atoms, such as a methoxy group, is preferred. It is particularly preferred that the terminal of the hydrophilic oxyalkylene chain is a hydroxy group.

The monomer having a hydrophilic polyoxyalkylene chain is preferably a monomer represented by the formula X¹³-L¹³-Y¹³ (hereinafter referred to also as monomer A13).

X¹³ is CH₂═CHO—, CH₂═CHCH₂O—, CH₂═CHOC(O)—, CH₂═CHCOO—, or CH₂═C(CH₃)COO—.

L¹³ is a divalent saturated hydrocarbon group having from 2 to 24 carbon atoms. The divalent saturated hydrocarbon group may be linear or branched. Further, the divalent saturated hydrocarbon group may be made of a ring structure, or it may contain a ring structure.

The divalent saturated hydrocarbon group is preferably a C₄₋₁₂ alkylene group, or an alkylene group containing a C₆₋₈ cycloalkylene group.

The divalent saturated hydrocarbon group is preferably a group represented by —CH₂-cycloC₆H₁₀—CH₂—, or a group represented by —CH₂CH₂—, —CH₂CH₂CH₂CH₂— or —CH₂CHR¹³—. Here, -cycloC₆H₁₀— represents a cyclohexylene group, and the binding sites of (-cycloC₆H₁₀—) are not particularly limited, but are usually 1,4-. R¹³ represents an alkyl group having from 1 to 10 carbon atoms.

Y¹³ is a group represented by the formula —O(MO)ₘR.

M is an alkylene group, and (MO)ₘ is a polyoxyethylene chain, or a polyoxyalkylene chain wherein some of m MO are oxyalkylene groups having 3 or more carbon atoms, and the rest is an oxyethylene group. (MO)ₘ is preferably a polyoxyethylene chain represented by (CH₂CH₂O)ₘ.

R is a hydrogen atom or an alkyl group, preferably a hydrogen atom.

m is an integer of from 6 to 24, preferably an integer of from 10 to 20.

Specific examples of monomer A13 may be CH₂═CHO—CH₂-cycloC₆H₁₀—CH₂—O(CH₂CH₂O)ₙ₁H, CH₂═CHCH₂O—CH₂-cycloC₆H₁₀—CH₂—O(CH₂CH₂O)ₙ₁H, CH₂═CHOCH₂CH₂O(CH₂CH₂O)ₙ₁H, CH₂═CHCH₂OCH₂CH₂O(CH₂CH₂O)ₙ₁H and CH₂═CHCH₂OCH₂CH(C₄H₉)O(CH₂CH₂O)ₙ₁H. In the formulae, n1 represents an integer of from 10 to 20.

Polymer A preferably contains monomer A13 among monomer A1, from the viewpoint of stain resistance of the present coating film. The reason for this is considered to be such that as polymer A contains units based on monomer A13, at the surface of the present coating film, the action of the specific anionic surfactant and the specific orientation of polymer B, will be helped, and at the same time, the role to exhibit the same functions as the later described nonionic surfactant will be fulfilled.

The HLB value of monomer A13 is preferably at most 15.0, particularly preferably at most 13.0, from such a viewpoint that stain resistance of the present coating film will be more excellent.

The content of units A1 is preferably from 0.1 to 20 mol %, more preferably from 0.8 to 15 mol %, particularly preferably from 1.0 to 10 mol %, to all units which polymer A comprises, from the viewpoint of stain resistance and film strength of the present coating film.

In a case where polymer A contains units based on monomer A13, the content thereof is preferably at most 15 mol %, more preferably from 0.1 to 10 mol %, particularly preferably from 0.3 to 5 mol %, to all units which polymer A comprises, from the viewpoint of hydrophilicity of the present coating film.

A part of the hydrophilic group of monomer A1 may act as a crosslinkable group. In a case where the hydrophilic group is a hydroxy group, at the time of preparing the present coating material, it is preferred to mix with an isocyanate type curing agent (a compound having two or more isocyanate groups) as a curing agent.

In a case where the hydrophilic group is a carboxy group, in the present coating material, it is preferred to mix, as a curing agent, a carbodiimide type curing agent (a compound having two or more carbodiimide groups), an amine type curing agent (a compound having two or more amino groups), an oxazoline type curing agent (a compound having two or more oxazoline groups) or an epoxy type curing agent (a compound having two or more epoxy groups).

Polymer A may contain units other than units F and units A1, from the viewpoint of flexibility of the present coating film. Such units may be units based on a vinyl ether, vinyl ester, allyl ether, allyl ester, (meth)acrylic acid ester or the like, not containing a hydrophilic group and fluorine atoms, and units (hereinafter referred to also as units A2) based on a monomer represented by the formula X²—Z² (hereinafter referred to also as monomer A2) are preferred.

X² is CH₂═CHC(O)O—, CH₂═C(CH₃)C(O)O—, CH₂═CHOC(O)—, CH₂═CHCH₂OC(O)—, CH₂═CHO— or CH₂═CHCH₂O—, and from the viewpoint of excellent weather resistance of the present coating film, CH₂═CHOC(O)—, CH₂═CHCH₂OC(O)—, CH₂═CHO— or CH₂═CHCH₂O— is preferred.

Z² is a monovalent hydrocarbon group having from 1 to 24 carbon atoms. The monovalent hydrocarbon group may be linear or branched, and it may be made of a ring structure, or it may contain a ring structure. Further, the monovalent hydrocarbon group may be a saturated hydrocarbon group or may be an unsaturated hydrocarbon group.

The monovalent hydrocarbon group is preferably an alkyl group, a cycloalkyl group, an aryl group or an aralkyl group, and a C₂₋₁₂ alkyl group, a C₆₋₁₀ cycloalkyl group, a C₆₋₁₀ aryl group or a C₇₋₁₂ aralkyl group is more preferred.

Specific examples of the alkyl group may be a methyl group, an ethyl group, a tert-butyl group, a hexyl group, a nonyl group, a decyl group, and a dodecyl group.

A specific example of the cycloalkyl group may be a cyclohexyl group.

A specific example of the aralkyl group may be a benzyl group.

A specific example of the aryl group may be a phenyl group, or a naphthyl group.

As monomer A2, two or more types may be used in combination.

Specific examples of monomer A2 may be ethyl vinyl ether, isobutyl vinyl ether, tert-butyl vinyl ether, 2-ethylhexyl vinyl ether, cyclohexyl vinyl ether, vinyl acetate, vinyl pivalate, vinyl neononanoate (HEXION tradename: VeoVa 9), vinyl neodecanoate (HEXION tradename: VeoVa 10), vinyl benzoate, methyl (meth)acrylate, tert-butyl (meth)acrylate, 2-ethylhexyl (meth)acrylate, and benzyl (meth)acrylate.

In a case where polymer A contains units A2, the content of units A2 is preferably from 1 to 70 mol %, particularly preferably from 10 to 50 mol %, to all units which polymer A comprises.

Polymer A preferably comprises units F, units A1 and units A2 in amounts of from 20 to 70 mol %, from 0.1 to 20 mol %, and from 0 to 70 mol %, in this order, in all units which polymer A has, and particularly preferably consists of units F, units A1 and units A2.

Mn of polymer A is, from the viewpoint of flexibility of the present coating film, preferably from 30,000 to 200,000, particularly preferably from 50,000 to 180,000.

In a case where polymer A has a hydroxy value, the hydroxy value is preferably from 1 to 80 mgKOH/g, more preferably from 5 to 60 mgKOH/g, particularly preferably from 8 to 20 mgKOH/g.

In a case where polymer A has an acid value, the acid value is preferably from 1 to 80 mgKOH/g, more preferably from 5 to 60 mgKOH/g, particularly preferably from 8 to 20 mgKOH/g.

Polymer A may have either one of the hydroxy value or the acid value, or may have both. When the hydroxy value and the acid value are within the above ranges, hydrophilicity of polymer A will be proper, and stain resistance of the present coating film will be excellent.

The content of polymer A is preferably from 40 to 95 mass %, particularly preferably from 50 to 90 mass %, to the total mass of the solid content which the present coating material comprises (hereinafter referred to also as the total solid content mass).

As polymer A, two or more types may be used in combination.

Polymer A is preferably applied to the present coating material in the form of an aqueous dispersion in which polymer A is dispersed in the form of particles in a solvent composed mainly of water. The solvent composed mainly of water, means a solvent containing water in an amount of at least 90%, preferably at least 99%, in the solvent. That is, the present coating material is preferably obtained by mixing an aqueous dispersion containing at least polymer A and the later described components other than polymer A.

The aqueous dispersion containing polymer A may contain such a specific anionic surfactant and a nonionic surfactant as described below, in addition to polymer A and water.

The aqueous dispersion containing polymer A may, for example, be prepared by polymerizing the above mentioned monomers in the presence of water, a surfactant, and a polymerization initiator. In the production of polymer A, as the case requires, a light stabilizer, a pH adjusting agent, etc. may be added.

In the following, polymer B will be described in detail.

Segment 1 is preferably composed of a homopolymer of monomer B1, a copolymer of at least two types of monomers B1, or a copolymer of at least one type of monomer B1 and at least one type of non-fluorinated monomer, more preferably composed of a homopolymer of monomer B1, or a copolymer of at least two types of monomers B1, particularly preferably composed of a homopolymer of monomer B1.

Monomer B1 is preferably a monomer represented by the formula X³-L³-RF (hereinafter referred to also as monomer B11).

X³ is CH₂═C(R¹)C(O)O—, CH₂═C(R¹)OCO—, CH₂═CHO— or CH₂═CHCH₂O—, and CH₂═C(R¹)C(O)O— is preferred. Said R¹ is a hydrogen atom, a methyl group, a fluorine atom, or a chlorine atom, and a hydrogen atom is preferred.

L³ is a single bond or a divalent linking group. The divalent linking group is preferably a divalent hydrocarbon group, more preferably a divalent aliphatic hydrocarbon group, particularly preferably a divalent alkylene group. The number of carbon atoms in the divalent hydrocarbon group is preferably from 1 to 10, more preferably from 1 to 5. The divalent hydrocarbon group may be linear or branched, may be made of a ring structure or may contain a ring structure. Said ring structure may be an aromatic ring. Further, the divalent linking group may be a group having a divalent hydrocarbon group and —O— combined.

R^{F} is a perfluoroalkyl group. The number of carbon atoms in the perfluoroalkyl group is, from the viewpoint of stain resistance of the present coating film, preferably from 1 to 30, particularly preferably from 1 to 6. The perfluoroalkyl group may be linear or branched.

Specific examples of monomer B11 may be CH₂═C(R¹)C(O)O(CH₂)₂(CF₂)₆F, CH₂═C(R¹)C(O)O(CH₂)₂(CF₂)₈F, CH₂═C(R¹)C(O)O(CH₂)₂(CF₂)₁₀F, CH₂═C(R¹)C(O)O(CH₂)₂(CF₂)₆CF(CF₃)₂, CH₂═C(R¹)C(O)O(CH₂)₂(CF₂)₈CF(CF₃)₂, and CH₂═C(R¹)OCOCH₂-Ph-O—(CF₂)₈F (Ph represents a phenylene group which may have a substituent group). Here, in the above formulae, the definition of R¹ is as described above.

Segment 1 may have units based on a non-fluorinated monomer (hereinafter referred to also as monomer B2), from the viewpoint of affinity with polymer A.

Monomer B2 is preferably an alkyl (meth)acrylate (hereinafter referred to also as monomer B22) having a C₁₂₋₂₀ alkyl group.

Specific examples of monomer B22 may be dodecyl (meth)acrylate, tridecyl (meth)acrylate, tetradecyl (meth)acrylate, pentadecyl (meth)acrylate, hexadecyl (meth)acrylate, octadecyl (meth)acrylate, and behenyl (meth)acrylate.

In polymer B, the content of units constituting segment 1 is preferably from 2 to 40 mol %, more preferably from 3 to 20 mol %, particularly preferably from 4 to 10 mol %, to all units which polymer B comprises, from such a viewpoint that polymer B is specifically disposed at the surface of the present coating film.

The content of units B1 in segment 1 is preferably at least 80 mol %, more preferably at least 85 mol %, particularly preferably at least 95 mol %, to all units which segment 1 comprises, from the viewpoint of stain resistance of the present coating film.

Segment 2 may be acceptable so long as it has no fluorine atom, and from such a viewpoint that water and oil repellency of the present coating film can be sustained, is preferably a homopolymer of monomer B2, or composed of a copolymer of at least two types of monomers B2.

The monomer B2 may be a (meth)acrylate. An alkyl (meth)acrylate is preferred, and a monomer represented by the formula X⁴—Y⁴ (hereinafter referred to also as monomer B21) is particularly preferred.

X⁴ is CH₂═CHC(O)O— or CH₂═C(CH₃)C(O)O—.

Y⁴ is a C₁₋₂₂ alkyl group or substituted alkyl group, a C₃₋₁₅ cycloalkyl group or substituted cycloalkyl group, or a phenyl group or substituted phenyl group.

Specific examples of the substituent may be a C₁₋₁₀ alkyl group, a hydroxy group, an ester group, a ketone group, an amino group, an amido group, an imido group, a nitro group, a carboxylic acid group, a thiol group, and an ether group.

Specific examples of monomer B21 may be an alkyl (meth)acrylate (such as methyl (meth)acrylate, ethyl (meth)acrylate, n-propyl (meth)acrylate, isopropyl (meth)acrylate, n-butyl (meth)acrylate, isobutyl (meth)acrylate, n-pentyl (meth)acrylate, n-hexyl (meth)acrylate, behenyl (meth)acrylate, 2-ethylhexyl (meth)acrylate, cyclohexyl (meth)acrylate, or a benzyl (meth) acrylate), a hydroxy group-containing (meth)acrylate (such as hydroxyethyl (meth)acrylate, diethylene glycol mono(meth)acrylate, polyethylene glycol mono(meth)acrylate, hydroxypropyl (meth)acrylate, or dipropylene glycol mono(meth)acrylate), glycidyl (meth)acrylate, and a nitrogen-containing (meth)acrylate (such as dimethylaminoethyl (meth)acrylate, diethylaminoethyl (meth)acrylate, 4-(meth)acryloyloxy-2,2,6,6-tetramethylpiperidine, or 4-(meth)acryloylamino-2,2,6,6-tetramethylpiperidine).

Segment 2 preferably has a hydrophilic group from such a viewpoint that polymer B is thereby specifically disposed at the surface of the present coating film. That is, segment 2 preferably contains units having a hydrophilic group. Specific examples and preferred embodiments of units having a hydrophilic group are the same as specific examples and preferred embodiments as described for units A1.

The monomer having a hydrophilic group is preferably a hydroxy group-containing vinyl monomer such as a compound exemplified above as a hydroxy group-containing (meth)acrylate.

Segment 2 is preferably a segment composed of units based on an alkyl (meth)acrylate and units based on a hydroxyalkyl (meth)acrylate, particularly preferably a segment composed of units based on methyl (meth)acrylate, units based on butyl (meth)acrylate and units based on hydroxyethyl (meth)acrylate, or a segment composed of units based on hydroxyethyl (meth)acrylate and units based on octadecyl (meth)acrylate.

In polymer B, the content of units constituting segment 2 is preferably from 60 to 98 mol %, more preferably from 80 to 97 mol %, particularly preferably from 90 to 96 mol %, to all units which polymer B comprises.

In polymer B, the content of units having a hydrophilic group is preferably from 1 to 20 mol %, more preferably from 5 to 17 mol %, to all units in polymer B.

In polymer B, when the content of segments 1 and 2 and the content of units based on a monomer having a hydrophilic group, are suitable, polymer B tends to be easily arranged alternately in the present coating surface, whereby it will be easy to improve the hydrophilicity and oil-repellency.

Here, in particular, in a case where polymer A wherein the content of said units A1 is from 0.1 to 20 mol %, and polymer B wherein the content of said units based on a monomer having a hydrophilic group is from 1 to 20 mol %, coexist, the present coating film will be excellent in stain resistance.

In a case where polymer B has a hydroxy value, the hydroxy value of polymer B is preferably from 10 to 100 mgKOH/g, more preferably from 15 to 90 mgKOH/g, particularly preferably from 30 to 70 mgKOH/g, from the viewpoint of adjusting the hydrophilicity of polymer B.

Mn of polymer B is preferably from 5,000 to 1,000,000, more preferably from 10,000 to 300,000, particularly preferably from 10,000 to 100,000, from such a viewpoint that polymer B is thereby likely to be retained in the present coating film.

The content of polymer B is preferably from 0.1 to 20 parts by mass, more preferably from 0.5 to 10 parts by mass, further preferably from 1 to 5 parts by mass, particularly preferably from 1 to 3 parts by mass, to 100 parts by mass of polymer A, from the viewpoint of stain resistance of the present coating film. As polymer B, two or more types may be used in combination.

Specific examples of polymer B may be MODIPER F206, MODIPER F246, MODIPER F906, MODIPER F3636, MODIPER F226, and MODIPER F606 (all tradenames of NOF Corporation).

The HLB value of the specific anionic surfactant is at least 17.5, and it is preferably at least 18.0, particularly preferably at least 19.0, from such a viewpoint that segment 1 and segment 2 of copolymer B tend to be easily arranged alternately on the surface of the present coating film, and stain resistance of the present coating film will be more excellent.

Specific examples of the specific anionic surfactant may be a fatty acid salt (in particular, a higher fatty acid salt), an alkyl sulfate, a polyoxyethylene alkyl ether sulfate, an alkyl benzene sulfonate, an α-sulfo fatty acid methyl ester salt, an α-olefin sulfonate, and an alkyl phosphoric acid ester salt. As the salt, a sodium salt is preferred. As the specific anionic surfactant, two or more types may be used in combination.

The content of the specific anionic surfactant is preferably from 0.01 to 5 parts by mass, more preferably from 0.03 to 3 parts by mass, particularly preferably from 0.05 to 1 part by mass, to 100 parts by mass of polymer A, from such a viewpoint that stain resistance of the present coating film will be more excellent.

Further, in particular, in a case where the content of polymer B to 100 parts by mass of polymer A is from 0.1 to 20 parts by mass, and the content of the specific anionic surfactant to 100 parts by mass of polymer A is from 0.01 to 5 parts by mass, polymer B will be specifically arranged at the surface of the present coating film, and stain resistance of the present coating material will be excellent.

The present coating material preferably contains a nonionic surfactant, from such a viewpoint that stain resistance of the present coating film will be more excellent. The reason for this is considered to be such that by the nonionic surfactant, dispersibility of polymer A and polymer B in the present coating material is improved.

The HLB value of the nonionic surfactant is preferably at most 15.0, more preferably at most 14.5, from such a viewpoint that stain resistance of the present coating film will be more excellent. Further, its lower limit value is preferably 10.0, more preferably 12.0.

Specific examples of the nonionic surfactant may be an alkyl phenyl polyoxyethylene, an alkyl polyoxyethylene, an alkyl polyoxyalkylene polyoxyethylene, a fatty acid ester, an alkylamine oxyethylene adduct, an alkylamide oxyethylene adduct, an alkylamine oxyethylene oxypropylene adduct, and an alkylamine oxide. As the nonionic surfactant, two or more types may be used in combination.

In a case where the present coating material contains a nonionic surfactant, from such a viewpoint that stain resistance of the present coating film will be more excellent, the content of the nonionic surfactant is preferably from 0.01 to 15 parts by mass, more preferably from 0.1 to 12 parts by mass, particularly preferably from 1 to 10 parts by mass, to 100 parts by mass of polymer A.

The present coating material may contain an anionic surfactant, but preferably contains both of an anionic surfactant and a nonionic surfactant. In such a case, it is considered that polymer A and polymer B are uniformly dispersed in the present coating material by the nonionic surfactant, whereupon the present coating film will be formed, whereby in the present coating film, the specific arrangement of polymer B becomes good, and stain resistance of the present coating film will be excellent.

In a case where the present coating material contains both of an anionic surfactant and a nonionic surfactant, the mass ratio of the anionic surfactant to the nonionic surfactant (mass of anionic surfactant/mass of nonionic surfactant) is preferably from 0.001 to 0.1, more preferably from 0.010 to 0.050.

The combination of an anionic surfactant and a nonionic surfactant is preferably an anionic surfactant selected from either a sulfuric acid ester salt or a fatty acid salt, and a nonionic surfactant selected from either an alkyl polyoxyethylene or an alkyl polyoxyalkylene polyoxyethylene.

When the mass ratio and combination of the anionic surfactant and the nonionic surfactant are within the above ranges, the present coating film will be more excellent in stain resistance.

The present coating material preferably contains the solid content in an amount of from 10 to 90 mass %, particularly preferably from 40 to 60 mass %, to the total mass of the present coating material.

The present coating material contains, as a coating solvent (dispersion medium), water only, or a mixture of water and a water-soluble organic solvent. The content of the coating solvent is preferably from 10 to 90 mass %, particularly preferably from 40 to 60 mass %, to the total mass of the present coating material.

Specific examples of the water-soluble organic solvent may be tert-butanol, propylene glycol, dipropylene glycol, dipropylene glycol monomethyl ether and tripropylene glycol.

When it contains a water-soluble organic solvent, the content of the water-soluble organic solvent is preferably from 1 to 40 parts by mass, to 100 parts by mass of water.

The present coating material may further contain additives such as, a surfactant other than the above-mentioned specific anionic surfactant and nonionic surfactant, a pigment (an inorganic coloring pigment, an organic coloring pigment, an extender pigment, etc.), a curing agent, a curing aid, a film-forming aid, a thickener, a defoaming agent, a leveling agent, a light stabilizer, an ultraviolet absorber, a surface modifier, a low pollution agent, etc. Further, the present coating material may further contain a polymer other than polymer A and polymer B (a fluorinated non-block copolymer other than polymer A, a fluorinated block copolymer other than polymer B, a polyvinylidene fluoride, a polyester resin, a polyurethane resin, an epoxy resin, a (meth)acrylic resin, an acrylic silicone resin, a melamine resin, a urea resin, a vinyl resin, a phenol resin, an alkyd resin, etc.).

The content of fluorine atoms to the total solid content mass of the present coating material is preferably from 10 to 40 mass %, more preferably from 13 to 30 mass %, particularly preferably from 15 to 25 mass %. When the content is at least 10 mass %, the present coating film will be excellent in weather resistance. When the content is at most 40 mass % or less, the present coating film will be excellent in flexibility.

The present coating material may, for example, be produced by mixing an aqueous dispersion containing polymer A and a specific anionic surfactant, polymer B, and optional components (a nonionic surfactant, additives, a polymer other than the polymers of the present invention, etc.). The outline of the aqueous dispersion is as described above.

The substrate with a coating film of the present invention has a substrate and a coating film (the present coating film) formed on the substrate by the present coating material.

Specific examples of the substrate may be an organic material such as a resin, a rubber, wood, etc., an inorganic material such as concrete, glass, ceramics, stone, etc., iron, an iron alloy, aluminum, and an aluminum alloy.

The thickness of the present coating film is preferably from 10 to 200 μm, more preferably from 10 to 100 μm. When the film thickness is at least 10 μm, blocking resistance of the present coating film will be improved, and when it is at most 200 μm, weather resistance of the present coating film will be improved.

The water contact angle to the present coating film is preferably less than 50°, more preferably at most 40°, further preferably less than 30°, particularly preferably less than 20°, from such a viewpoint that stain resistance of the present coating film will be more excellent.

The oil contact angle to the present coating film is preferably at least 40°, particularly preferably at least 50°, from such a viewpoint that stain resistance of the present coating film will be more excellent.

The present coating film is provided with hydrophilicity and oil repellency, whereby dirt is less likely to deposit thereon, and dirt, even when once deposited, can be easily removed. Therefore, to the present coating film, the water contact angle is preferably less than 50°, and the oil contact angle is preferably at least 40°.

The water contact angle and the oil contact angle to the present coating film can be suitably adjusted by the type, amount, etc. of polymer A, polymer B and the specific anionic surfactant, in the present coating material.

The method for producing a substrate with a coating film of the present invention, is a method of applying the present coating material to the surface of a substrate to form a coating layer, and drying the coating layer to form the present coating film. In a case where the present coating material contains a curing agent, it is preferred to conduct heating after the above drying for the curing.

The present coating material may be applied directly to the surface of a substrate, or may be applied thereon after a known surface treatment (primer layer treatment, etc.) has been applied to the surface of the substrate. Further, after forming an undercoat layer on a substrate, it may be applied on the undercoat layer.

A specific example of the method for applying the present coating material may be a method of using an application device such as a brush, a roller, dipping, spraying, a roll coater, a die coater, an applicator or a spin coater. The drying and curing temperatures after the application are preferably from 20 to 300° C., more preferably from 20 to 250° C.

As mentioned above, the present aqueous coating material is excellent in stain resistance, and therefore can be suitably used for a wall material in house building, a surface material for a household good, an aluminum fin in an indoor or outdoor unit of an air conditioner or the like, a head-mounted display of a game machine or the like, a lens for a surveillance camera or vehicle camera, a protective case, etc.

### EXAMPLES

In the following, the present invention will be specifically described with reference to Examples. However, the present invention is not construed as being limited to these Examples. Here, the blend amounts of the respective components in the following Table, show the mass basis. Ex. 7 to 10, 13 and 14 are Examples of the present invention, and Ex. 11, 12, 15 and 16 are Comparative Examples.

### (Abbreviations of Compounds, Etc.)

CTFE: chlorotrifluoroethylene

HEAE: CH₂═CHCH₂OCH₂CH₂OH

CHMVE: CH₂═CHO—CH₂-cycloC₆H₁₀—CH₂OH CM-15EOVE: CH₂═CHO—CH₂-cycloC₆H₁₀—CH₂—O—CH₂CH₂O)₁₅H (HLB value: at most 15.7)

IVE: isobutyl vinyl ether, MMA: methyl methacrylate,

2-EHMA: 2-ethylhexyl methacrylate

CHVE: cyclohexyl vinyl ether, EVE: ethyl vinyl ether

2-EHVE: 2-ethylhexyl vinyl ether

Anionic surfactant 1: C₁₄H₂₉CO—(OCH₂CH₂)₁₁—OSO₃⁻Na⁺ (HLB: more than 20)

Anionic surfactant 2: C₁₂H₂₅OSO₃⁻Na⁺ (HLB: more than 20)

Anionic surfactant 3: C₁₇H₃₅COOCH(CH₃)COO⁻Na⁺ (HLB: 17.0)

Nonionic surfactant 1: C₁₄H₂₉CO—(OCH₂CH₂)₁₁—OH (HLB: 12.6)

Nonionic surfactant 2: C₁₂H₂₅—(OCH₂CH₂)₁₃—OH (HLB: 14.1)

Nonionic surfactant 3: C₁₂H₂₅—(OCH₂CH₂)₂₁—OH (HLB: 15.5)

Nonionic surfactant 4: C₁₃H₂₇—(OCH₂CH₂)₁₀—OH (HLB: 12.8)

Nonionic surfactant 5: C₁₃H₂₇—(OCH₂CH₂)₂₁—OH (HLB: 15.2)

### [Ex. 1] Production Example of Polymer A1

Into a vacuum-deaerated autoclave, CTFE (402 g), HEAE (71.4 g), IVE (156 g), MMA (295 g), 2-EHMA (134 g), ion-exchanged water (927 g), nonionic surfactant 1 (50 g), and anionic surfactant 1 (1.0 g) were introduced with stirring. Then, into the autoclave, a 0.5 mass % ammonium persulfate aqueous solution (100 g) was introduced, and polymerization was conducted for 24 hours, whereupon the solution in the autoclave was filtered, to obtain an aqueous dispersion A1 containing particles of polymer A1 being a fluorinated non-block copolymer (concentration of polymer A1: 50 mass %, hydroxy value: 26 mgKOH/g).

Polymer A1 was a polymer comprising units based on CTFE, units based on HEAE, units based to IVE, units based on MMA and units based on 2-EHMA, in amounts, in this order, of 34 mol %, 7 mol %, 8 mol %, 42 mol % and 9 mol %, to all units which polymer A1 comprises.

### [Ex. 2] Production Example of Polymer A2

An aqueous dispersion A2 containing particles of polymer A2 being a fluorinated non-block copolymer (concentration of polymer A2: 50 mass %, hydroxy value: 10 mgKOH/g) was obtained in the same manner as in Ex. 1, except that the types and amounts of monomers and surfactants to be used, were changed to CTFE (473 g), CHVE (338 g), 2-EHVE (187 g), CHMVE (27.6 g), CM-15EOVE (20 g), nonionic surfactant 2 (32 g), nonionic surfactant 4 (20 g) and anionic surfactant 2 (1.0 g), and potassium carbonate (2.6 g) was added.

Polymer A2 was a polymer comprising units based on CTFE, units based on CHVE, units based on 2-EHVE, units based on CHMVE and units based on CM-15EOVE, in amounts, in this order, of 50 mol %, 33 mol %, 14.7 mol %, 2 mol % and 0.3 mol %, to all units which polymer A2 comprises.

### [Ex. 3] Production Example of Polymer A3

An aqueous dispersion A3 containing particles of polymer A3 being a fluorinated non-block copolymer (concentration of polymer A3: 50 mass %, hydroxy value: 49 mgKOH/g) was obtained in the same manner as in Ex. 1, except that the types and amounts of monomers and surfactants to be used, were changed to CTFE (553 g), EVE (140 g), CHVE (228 g), CHMVE (161 g), CM-15EOVE (39 g), nonionic surfactant 3 (30 g), nonionic surfactant 5 (26 g) and anionic surfactant 2 (1.1 g), and potassium carbonate (1.7 g) was added.

Polymer A3 is a polymer comprising units based on CTFE, units based on EVE, units based on CHVE, units based on CHMVE and units based on CM-15EOVE, in amounts, in this order, of 50 mol %, 20.5 mol %, 19 mol %, 10 mol % and 0.5 mol %, to all units which polymer A3 comprises.

### [Ex. 4] Production Example of Polymer A4

An aqueous dispersion A4 containing particles of polymer A4 being a fluorinated non-block copolymer (concentration of polymer A4: 50 mass %, hydroxy value: 26 mg KOH/g) was obtained in the same manner as in Ex. 1, except that anionic surfactant 1 was changed to anionic surfactant 3.

### [Ex. 5] Production Example of Polymer A5

An aqueous dispersion A5 containing particles of polymer A5 being a fluorinated non-block copolymer (concentration of polymer AS: 50 mass %, hydroxy value: 26 mg KOH/g) was obtained in the same manner as in Ex. 2, except that anionic surfactant 2 was changed to anionic surfactant 3.

### [Ex. 6] Production Example of Aqueous Coating Material

The aqueous dispersions obtained in Ex. 1 to 5, film-forming aid, thickener, defoamer, and polymer B1 were mixed as shown in Table 1, to obtain aqueous coating materials 1 to 10. Here, details of the film-forming aid, thickener, defoamer and polymer B1 are as follows.

Further, the content of fluorine atoms to the total mass of each aqueous coating material is shown in Table 1.

Film-forming aid: CS-12 (NIPPON NYUKAZAI CO., LTD. tradename)

Thickener: RHEOLATE 288 (ELEMENTIS tradename)

Defoamer: BYK-028 (BYK tradename)

Polymer B1: a fluorinated block copolymer having the following fluorinated segment and non-fluorinated segment.
Fluorinated segment; segment comprising units based on a perfluorohexylethyl methacrylate.
Non-fluorinated segment; segment based on units based on hydroxyethyl acrylate, units based on butyl methacrylate, and units based on methyl methacrylate.
To all units which polymer B1 comprises, the contents of units based on perfluorohexylethyl methacrylate, units based on hydroxyethyl acrylate, units based on butyl methacrylate, and units based on methyl methacrylate, are, in this order, 6 mol %, 9 mol %, 35 mol %, and 50 mol %.

### [Ex. 7 to 16] Production Examples of Substrate with Coating Film

On the surface of an aluminum plate (vertical 200 mm, horizontal 125 mm, thickness 0.8 mm), an undercoating material (SK KAKEN Co., Ltd. tradename: SK clear sealer) was applied by an applicator, so that the dried film thickness became to be 15 μm, and dried at 25° C. for 2 weeks, to form an undercoat film.

Then, on the surface of the undercoat film, aqueous coating material 1 was applied by an applicator so that the dried film thickness became to be 40 μm, to form a coating layer. Thereafter, this coating layer was dried at 25° C. for two weeks to form a coating film, to obtain a substrate 1 with a coating film formed from the aqueous coating material 1, which was used as a test piece 1.

Also with respect to the respective aqueous coating materials 2 to 10, test pieces 2 to 10 were, respectively, obtained in the same manner as the preparation of the above test piece 1, using the respective aqueous coating materials.

The obtained respective test pieces 1 to 10 were subjected to the following evaluations. Their results are summarized and shown in the following Table 1.

### [Evaluation of Coating Films]

### [Hydrophilicity of Coating Films]

With respect to each test piece, the static contact angle of water (water contact angle) to the test piece was measured, and the hydrophilicity of the coating film was evaluated based on the following standards.

Using a contact angle measuring device (FACE tradename, CA-X model), pure water with a diameter of from 1 to 2 mm was dropped on the surface of the test piece, and the liquid droplet after 30 seconds from dropping was photographed by a video camera and subjected to an image analysis. Twice the angle of the straight line connecting the end point and the apex of the droplet, to the test piece, was taken as a measured value of the static contact angle. The measurement was conducted three times, and the average value of the obtained measured values was taken as the value of the static contact angle, whereby an evaluation was made as follows.

S: The static contact angle of water to the test piece is less than 20°.

A: The static contact angle of water to the test piece is at least 20° and less than 30°.

B: The static contact angle of water to the test piece is at least 30° and less than 50°.

C: The static contact angle of water to the test piece is at least 50°.

### [Oil Repellency of Coating Films]

With respect to each test piece, the static contact angle of liquid paraffin (oil contact angle) to the test piece was measured, and oil repellency of the coating film was evaluated based on the following standards.

Using a contact angle measuring device (FACE tradename, CA-X model), liquid paraffin with a diameter of from 1 to 2 mm was dropped on the surface of the test piece, and the liquid droplet after 30 seconds from the dropping, was photographed by a video camera and subjected to an image analysis. Twice the angle to the test piece, of the straight line connecting the end point and the apex of the liquid droplet, was taken as a measured value of the static contact angle. The measurement was conducted three times, and the average value of the obtained measured values was taken as the value of the static contact angle, whereby an evaluation was made as follows.

A: The static contact angle of the liquid paraffin to the test piece is at least 50°.

B: The static contact angle of the liquid paraffin to the test piece is at least 40° and less than 50°.

C: The static contact angle of the liquid paraffin to the test piece is less than 40°.

### [Stain Resistance of Coating Films]

With respect to each test piece, an oily marker (Shachihata Inc. tradename, Artline Oily Marker) was deposited on the coating film surface, and then the entire coating film was wetted with ion-exchanged water and allowed to stand still for 10 seconds. Then, the oily marker on the coating film surface was wiped off by BEMCOT, and whether or not the concentration of the oily marker was decreased, was visually evaluated based on the following standards.

S: The concentration of the oily marker on the coating film surface after wiping is at most 5% as compared to the concentration before wiping.

A: The concentration of the oily marker on the coating film surface after wiping is more than 5% and at most 30% as compared to the concentration before wiping.

B: The concentration of the oily marker on the coating film surface after wiping is more than 30% and at most 80% as compared to the concentration before wiping.

C: The concentration of the oily marker on the coating film surface after wiping is more than 80% as compared to the concentration before wiping.

TABLE 1

| | Ex. 7 | Ex. 8 | Ex. 9 | Ex. 10 | Ex. 11 | Ex. 12 | Ex. 13 | Ex. 14 | Ex. 15 | Ex. 16 |
|---|---|---|---|---|---|---|---|---|---|---|
| No. of aqueous coating material and test piece | 1 | 2 | 3 | 4 | 5 | 6 | 7 | 8 | 9 | 10 |
| Aqueous dispersion A1 (g) | 80 | | | | | | | | 80 | |
| Aqueous dispersion A2 (g) | | 80 | 80 | | | | 80 | 80 | | 80 |
| Aqueous dispersion A3 (g) | | | | 80 | | | | | | |
| Aqueous dispersion A4 (g) | | | | | 80 | | | | | |
| Aqueous dispersion A5 (g) | | | | | | 80 | | | | |
| Film-forming aid (g) | 4.8 | 4.8 | 4.8 | 4.8 | 4.8 | 4.8 | 4.8 | 4.8 | 4.8 | 4.8 |
| Defoamer (g) | 0.3 | 0.3 | 0.3 | 0.3 | 0.3 | 0.3 | 0.3 | 0.3 | 0.3 | 0.3 |
| Thickener (g) | 0.3 | 0.3 | 0.3 | 0.3 | 0.3 | 0.3 | 0.3 | 0.3 | 0.3 | 0.3 |
| Polymer B1 (g) | 0.6 | 0.6 | 1.2 | 0.6 | 0.6 | 0.6 | 2 | 4 | | |
| Content of fluorine atoms (mass %) | 16.5 | 19.7 | 19.8 | 21.4 | 16.5 | 19.7 | 20.1 | 20.6 | 16.3 | 19.5 |
| Hydrophilicity of coating film | B | S | A | B | C | C | A | B | C | A |
| Oil repellency of coating film | A | A | A | B | A | A | A | A | A | C |
| Stain resistance of coating film | B | S | S | B | C | C | A | B | C | C |

As shown in Table 1, Ex. 7 to 10, 13, and 14 are excellent in stain resistance as well as in hydrophilicity and oil repellency of the coating film, as compared to Comparative Ex. 11, 12, 15, and 16.

What is claimed is:

1. An aqueous coating material characterized by comprising
a fluorinated non-block copolymer which comprises units based on a fluoroolefin and units having a hydrophilic group,
a fluorinated block copolymer which has a fluorinated segment comprising units based on a monomer having a perfluoroalkyl group, and a non-fluorinated segment containing no fluorine atom,
an anionic surfactant, of which the HLB value is at least 17.5, and
water.

2. The aqueous coating material according to claim 1, wherein the hydrophilic group is a hydroxy group, a carboxy group, or a group having a hydrophilic polyoxyalkylene chain.

3. The aqueous coating material according to claim 1, wherein the units having a hydrophilic group are units based on a monomer having a hydrophilic group.

4. The aqueous coating material according to claim 1, which further contains a nonionic surfactant, of which the HLB value is at most 15.0.

5. The aqueous coating material according to claim 4, wherein the content of the nonionic surfactant is from 0.01 to 15 parts by mass, to 100 parts by mass of the fluorinated non-block copolymer.

6. The aqueous coating material according to claim 1, wherein content of the fluorinated block copolymer is from 0.1 to 20 parts by mass, to 100 parts by mass of the fluorinated non-block copolymer, and the content of the anionic surfactant is from 0.01 to 5 parts by mass, to 100 parts by mass of the fluorinated non-block copolymer.

7. The aqueous coating material according to claim 1, wherein the fluorinated block copolymer contains units having a hydrophilic group, and units based on an alkyl (meth)acrylate.

8. The aqueous coating material according to claim 7, wherein in the fluorinated non-block copolymer, the content of the units having a hydrophilic group is from 0.1 to 20 mol % to all units which the fluorinated non-block copolymer comprises, and in the fluorinated block copolymer, the content of the units having a hydrophilic group is from 1 to 20 mol % to all units which the fluorinated block copolymer comprises.

9. The aqueous coating material according to claim 1, wherein the content of the water is from 10 to 90 mass %, to the total mass of the aqueous coating material.

10. The aqueous coating material according to claim 7, wherein in each of the fluorinated non-block copolymer and the fluorinated block copolymer, the hydrophilic group includes a hydroxy group,
the hydroxy value in the fluorinated non-block copolymer is from 1 to 80 mgKOH/g, and
the hydroxy value in the fluorinated block copolymer is from 10 to 100 mgKOH/g.

11. The aqueous coating material according to claim 1, wherein the content of the fluorinated non-block copolymer to the total mass of the solid content which the aqueous coating material comprises, is from 40 to 95 mass %.

12. The aqueous coating material according to claim 1, wherein the content of fluorine atoms to the total mass of the solid content which the aqueous coating material comprises, is from 10 to 40 mass %.

13. A method for producing a substrate with a coating film, characterized by applying the aqueous coating material as defined in claim 1 on the surface of a substrate, to form a coating layer, and drying the coating layer to form a coating film.

14. A coating film formed from the aqueous coating material as defined in claim 1, characterized in that the water contact angle to the coating film is less than 50°, and the oil contact angle to the coating film is at least 40°.
